(19) United States
(12) Patent Application Publication
(10) Pub. No.: US 2010/0043494 A1
(43) Pub. Date: Feb. 25, 2010

(54) PROCESS FOR FABRICATING A MICROFLUIDIC DEVICE

(76) Inventors: Helene Gascon, Paris (FR); Geraldine Duisit, Paris (FR); Edouard Brunet, Paris (FR)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/440,874

(22) PCT Filed: Sep. 6, 2007
(86) PCT No.: PCT/FR07/51878

§ 371 Date: Mar. 11, 2009

(30) Foreign Application Priority Data
Sep. 12, 2006 (FR) 0607981

(51) Int. Cl. C03C 27/00

(52) U.S. Cl. 65/43

(57) ABSTRACT

The invention relates to a method of fabricating “open” microfluidic devices by screen printing. The method comprises steps consisting in:
a) depositing a mixture of a glass, glass-ceramic or ceramic precursor material and of an organic medium onto said substrate, which is made of a material chosen from glass, glass-ceramic and ceramic, by screen printing in order to form at least one screen-printed feature in a desired pattern, each feature corresponding to a microfluidic device; and
b) firing the screen-printed feature(s) at a temperature allowing the precursor material to bond to the substrate by melting.

The subject of the invention is also a method of fabricating microfluidic devices that are “closed” by a sheet of glass, glass-ceramic or ceramic.

The present invention relates to a method of fabricating a microfluidic device.

Microfluidic devices are known structures used in chemistry, in particular in the following fields:
microreaction, with the aim of producing all kinds of compounds (molecules, particles, emulsions, etc.) from starting reactants introduced into a microfluidic device, which acts as synthesis reactor; and
microanalysis, with the aim of detecting specific compounds, and generally of measuring their content, in specimens of a variety of sources, in particular in biological fluids. The microfluidic device provides here the detection function.

The role of microfluidic devices is however not limited to the aforementioned functions. In particular, the microfluidic devices may be designed to function as heat exchangers, filters, mixers, extractors, separators (for example those operating by electrophoresis), devices for generating droplets of a given size or solid particles, or as devices for carrying out particular operations (cell lysis, DNA amplification, etc.).

These devices may be “open”, that is to say they may be composed of only a single element on which features defining microstructures, for example microchannels and microreservoirs, are etched or deposited.

More generally, microfluidic devices are “closed”. They comprise two elements, in plate or sheet form, which are juxtaposed and linked together, at least one of the elements being etched or being provided with features on the surface that faces the other element in order to form the microstructures, which microstructures are fluid-tight. In general, the microfluidic devices include openings in the element(s) which open into one or more microstructures for the introduction and discharge of the fluids.

A very small volume of fluids is stored in or made to flow through the microstructures for the purpose either of making the compounds contained in these fluids react (together or with one or more compounds introduced beforehand into the microfluidic device) or to mix or separate the constituents of a portion of a fluid so as to analyze their chemical and/or physical properties, inside or outside the microfluidic device. It is also possible to make a fluid flow through a microstructure simply in order to measure one of its chemical or physical properties.

In general, the microstructures have an approximately square, rectangular, trapezoidal, oval or circular cross section and have a thickness that varies from 1 to 1000 μm, preferably from 10 to 500 μm. The dimensions of the microstructures vary according to whether it is a channel, a reservoir or a connection element for said channel or said reservoir. Usually, the width is between 10 and 1000 μm, the length may range from a few millimeters to several centimeters, and the area may vary from 1 to 100 square centimeters.

Microfluidic devices may be made of materials of different natures.

For example, they may be made of a polymer, silicon or metal. However, these materials are unsatisfactory on a number of counts:
polymers are sensitive to organic solvents (they have a tendency to dissolve and to swell), have difficulty in resisting prolonged treatments at temperatures above 200-300° C., deform under the effect of pressure, and are not entirely chemically inert (they may adsorb compounds present in the fluids, and possibly discharge them subsequently). Furthermore, the surface finish of polymers is difficult to control, in particular because they evolve over the course of time. Finally, certain polymers are not suitable for spectroscopy detection techniques in general, and Raman spectroscopy in particular, owing to perturbations that they may give rise to;
silicon is expensive, is not compatible with certain fluids, is not transparent and its semiconductor character prevents the use of electrodynamic and electroosmotic pump techniques. In addition, the methods used to form the microstructures, such as photolithography and DRIE (deep reactive ion etching) are expensive as they require working in protective chambers under a controlled atmosphere; and
metals are liable to corrode and are neither transparent nor compatible with certain biological fluids.

To remedy the aforementioned drawbacks, it has been proposed to fabricate microfluidic devices from glass, glass-ceramic or ceramic.

These materials are appreciated for their insulating nature which allows fluids to be transported by electrokinetic or electroosmotic processes, for their chemical inertness, their good surface finish and their capability of being chemically surface-modified in a lasting manner.

Glass is preferred for its cost, its processability and its transparency, allowing compounds present in the fluids to be detected by optical methods.

In a glass element, the channels may be obtained by physical etching, especially by sandblasting and by irradiation by means of a CO₂ laser (JP-A-2000-298109), or by direct chemical etching of the glass or of a consolidated layer based on a glass powder deposited beforehand on the glass (JP-A-2003-299944).

However, physical and chemical etching processes may impair the surface of the glass element, making it liable to scatter light, so that it is no longer possible to use optical detection methods operating in the visible with this type of microfluidic device. Furthermore, the etched surface has too high a level of roughness for the intended application, which it is necessary to correct by applying additional treatments, for example heat or chemical treatments or for example using an acid.

The microstructures may also be obtained by vacuum-forming a precursor material for a glass, for a glass-ceramic or for a ceramic on the glass element (FR-A-2830206). This method requires specific vacuum devices which are all the more expensive the larger the elements to be treated.

It is an object of the present invention to produce microfluidic devices with a higher productivity and more economically than the prior methods.

The first subject of the invention is a method of fabricating an “open” microfluidic device comprising a substrate provided with at least one microstructure, in particular in the form of a channel or reservoir, which process comprises the steps consisting in:

a) depositing a mixture of a glass, glass-ceramic or ceramic precursor material and of an organic medium onto said substrate, which is made of a material chosen from glass, glass-ceramic and ceramic, by screen printing in order to form at least one screen-printed feature in a desired pattern, each feature corresponding to a microfluidic device; and

b) firing the screen-printed feature(s) at a temperature allowing the precursor material to bond to the substrate by melting.

The method according to the invention is advantageous in that it includes a screen-printing step making it possible in particular to print several features on one and the same substrate.

Screen-printing is a printing technique well known to those skilled in the art, it is inexpensive, enables increased productivity and can be adapted to all kinds of features.

According to the invention, the features are formed by screen-printing by making the mixture of glass, glass-ceramic or ceramic precursor material and organic medium pass through a screen on which the pattern to be reproduced on the substrate is printed.

The precursor material of step a) must be able to melt so as to give a glass, a glass-ceramic or a ceramic at a temperature below the melting point of the substrate, and thus, by melting be bonded to the substrate.

In general, this material takes the form of a fine powder consisting of particles with a size sufficiently small to be able to pass through the meshes of the screen-printing screen, for example a mean size not exceeding 100 μm, preferably between 1 and 50 μm, and advantageously between 1 and 20 μm. Preferably, the powder has a monodisperse distribution.

As a general rule, the precursor material has a thermal expansion coefficient close to that of the substrate so as to prevent the tensile stresses appearing after the firing, and to limit the risks of the final microfluidic device breaking. Thus, the difference between the thermal expansion coefficient of the precursor material and the thermal expansion coefficient of the substrate does not exceed 40×10⁻⁷ K⁻¹, preferably does not exceed 20×10⁻⁷ K⁻¹, and advantageously does not exceed 10×10⁻⁷ K⁻¹.

Advantageously, the glass precursor material is chosen from frits consisting of a glass based on lead oxide, for example the C80F frit from Ferro, a glass based on zinc and boron oxides, for example the frit VN821BJ from Ferro, and a glass based on bismuth oxide, especially with the following composition, in percentages by weight:

| | |
|---|---|
| Bi₂O₃ | 50-70% |
| SiO₂ | 15-30% |
| B₂O₃ | 1-13% |
| Al₂O₃ | 0.5-7% |
| Na₂O | 0.5-7% |

advantageously satisfying the equation: Na₂O+B₂O₃+Al₂O₃=7.5−18%. It turns out that frits of the latter glass type containing bismuth make it possible to obtain particularly sought-after transparent features.

A function of the organic medium is to give the mixture a viscosity enabling it to pass through the screen and making it possible for the shape of the feature on the substrate to be retained until the firing step. It may be chosen from media known to those skilled in the art, such as oils, especially pine oil or castor oil. The amount of medium in the mixture depends on the nature of the precursor material and on the desired viscosity.

The mixture may also contain other compounds for giving the channels specific properties, for example one or more metal oxides or metals, or mineral compounds.

The screen for the screen-printing is adapted to the conditions of application on the substrate.

Preferably, the screen has a small opening so as to obtain good resolution of the feature(s) to be printed.

Furthermore, the screen is chosen so as to allow the mixture to be deposited with a thickness of between 1 and 1000 μm, preferably equal to 200 μm or less.

Where appropriate, it is possible to carry out several successive deposition operations so as to obtain greater mixture thicknesses on the substrate.

The substrate on which the screen-printed feature(s) is(are) applied may be made of glass, glass-ceramic or ceramic.

Although it can vary widely, the thickness of the substrate is preferably small, especially less than 4 mm, advantageously 2 mm or less and better still 1 mm or less.

Preferably, the substrate is made of glass, especially soda-lime-silicate glass or borosilicate glass.

The substrate may be coated with a functional layer on all or part of the face on which said at least one feature is deposited, it being possible for the functional layer to be continuous or discontinuous, especially to form features that are identical to or different from the features to be screen-printed.

As examples of such layers, mention may be made of conducting, especially electrically conducting, layers, heating layers, insulating layers, hydrophilic or hydrophobic layers, layers that adsorb one or more constituents of the fluid(s) introduced into the microfluidic device, catalytic, especially photocatalytic, layers, metallic layers, especially those allowing detection by magnetic methods, layers having a mirror effect, antireflection layers, low-emissivity or low-E layers, antifrosting layers, antifogging layers, solar-protection layers, etc. Conducting layers are preferred, especially because they allow the production of electrodes, and metallic layers because they allow the use of in situ detection methods in the microstructures, especially in the channels.

The substrate may also include microstructures on all or part of the face on which the screen-printing mixture is deposited.

Advantageously, the substrate has large dimensions so that several features can be screen-printed simultaneously and so that, consequently, it is possible to obtain a large number of microfluidic devices in a single operation. Thus, it is possible to use substrates having an area that may be up to several square meters, thereby enabling several hundred microfluidic devices to be produced on a single substrate.

In step b), the screen-printed feature(s) is(are) fired at a temperature sufficient to melt the precursor mixture and allow it to be bonded to the substrate in a lasting manner.

The firing temperature depends on the nature of the precursor material, the nature of the substrate and possibly of the functional layers and of the microstructures present on the face intended for deposition of the screen-printing mixture.

Preferably, the firing temperature is above the melting point of the precursor material, advantageously at least 50° C. above it, but below the melting point of the substrate.

When the substrate is made of glass, the firing temperature is usually below the strain point temperature (the temperature at which the glass has a viscosity of 10^{14.5} poise) plus 200° C.

The firing time may vary from 1 to 50 minutes, preferably from 3 to 20 minutes.

Preferably, the firing step starts at a low temperature so as firstly to consolidate the precursor material and to remove the organic medium, and secondly to bond the precursor material to the substrate by melting.

It is important that the cooling be carried out at not too high a rate so that the tensile stresses in the substrate are as low as possible so that, where appropriate, it can be cut correctly. The cooling rate is preferably less than 200° C. per minute, advantageously between 5 and 100° C. per minute.

Another subject of the invention is a method of fabricating a “closed” microfluidic device comprising at least two substrates and at least one microstructure, characterized in that it comprises the steps consisting in:

a) depositing a mixture of a glass, glass-ceramic or ceramic precursor material and of an organic medium on a first substrate by screen-printing in order to form at least one screen-printed feature in a desired pattern, said first substrate being made of a material chosen from glass, glass-ceramic and ceramic, and each feature corresponding to a microfluidic device;

b) optionally drying said screen-printed feature(s) at a temperature sufficient to remove the organic medium;

c) depositing a second substrate made of a material chosen from glass, glass-ceramic and ceramic, which is identical to or different from said first substrate, on the screen-printed feature(s); and

d) firing the assembly obtained at a temperature allowing the precursor material to bond to the substrates by melting.

Step a) is carried out under the same conditions as step a) of fabricating the open microfluidic device(s).

In step b), the screen-printed feature(s) is(are) subjected to a heat treatment for the purpose of drying and of removing the organic medium. The purpose of this treatment is to prevent the formation of bubbles arising from the decomposition of the medium during the subsequent firing step, these bubbles being liable to create pores within the precursor material that would impair the fluid-tightness of the final microfluidic device.

The temperature depends on the nature of the medium used. In general, it is between 50 and 200° C., preferably around 100° C.

The drying time may vary from 1 to 30 minutes, preferably 1 to 20 minutes.

The drying also makes it possible for the feature(s) on the first substrate to be temporarily fixed and to improve its (their) mechanical strength while being placed on the second substrate in the next step c).

The second substrate may be identical to the first substrate, or it may differ by its dimensions and/or the nature of the constituent material and/or the functional layers and/or the microstructuring present on the surface of the face that faces the features. Advantageously, the second substrate consists of the same material as the first substrate.

The second substrate may include, on said face, one or more screen-printed features based on a precursor material compatible with that of the first substrate, for the purpose of increasing the thickness of the microstructures in the microfluidic device(s).

Preferably, the thermal expansion coefficient of the second substrate is compatible with that of the precursor material present on the first substrate, and consequently is also compatible with that of the first substrate.

In step d), the assembly consisting of the substrates and the screen-printed features is fired at a temperature allowing the glass, glass-ceramic or ceramic precursor material to melt so that the two substrates are bonded to the glass, the glass-ceramic or the ceramic, forming microstructures that are impermeable to liquid and gaseous fluids.

Optionally, pressure may be applied to the second substrate during the firing so as to ensure better contact between the substrates and the screen-printed features, and thus improve the quality of the bonding, especially to limit the risks of leakage within the microstructures.

Just as in step b) described for producing open microfluidic devices, the firing temperature must be above the melting point of the precursor material but below the melting point of the substrate having the lowest melting point.

Preferably when the substrates are made of glass, the firing temperature is below the strain point temperature of the substrate having the lowest strain point temperature plus 200° C. In this way, the firing time varies from 1 to 50 minutes, preferably 3 to 20 minutes.

According to one way of implementing the method according to the invention, spacers may be placed between the substrates for the purpose of keeping the distance that separates them constant.

The spacers are generally placed on one or both substrates, before they are assembled and fired, in order to bond them together. They are preferably placed on the first substrate.

The spacers may be introduced into the precursor material before application to the substrate(s), for example in the form of particles having a size matched to the desired spacing and consisting of a material that is resistant to the firing. Preferably, the particles are spherical.

The spacers may also be introduced into a precursor mixture identical to or different from that constituting the feature(s) and applied separately outside the features, for example in the zone separating the features (i.e. between the features) or in the peripheral zone of the first and/or of the second substrate. The mixture may be deposited in the form of spots, or continuous or broken lines over all or part of the aforementioned zone.

The spacers may also be separate elements of appropriate shape and dimensions, for example balls, cylinders or cruciform elements that are deposited on the surface of one of the substrates. Where appropriate, the spacers may be held in place by means of an adhesive material that leaves no residue after firing.

The methods of the invention may include, in addition to the steps described above, the following steps:
the cutting of the substrate(s), in particular when several screen-printed features are present.

In the case of open microfluidic devices, the cutting may be carried out on the substrate after step a) of depositing the mixture, or on the substrate after the firing step b).

In the case of closed microfluidic devices, the cutting may be carried out on the first and/or the second substrate. Preferably, the cutting of the first substrate is carried out after step a) or b), advantageously after step d), and the cutting of the second substrate is carried out after step d).

According to a first implementation variant, the first substrate is cut after step a), preferably after step b), and assembled with a second substrate having dimensions substantially identical to the first, cut substrate.

According to a second implementation variant, both substrates are cut after step d).

The cutting may be carried out by any known means, for example by means of a diamond-wheel device, or using a laser. It is generally carried out between the features, with a distance matched to the cutting mode chosen, in zones that may have undergone a treatment for the purpose of embrittling the substrate (for example precracking it) or which have been formed for example by an adapted screen-printing feature (the cutting being carried out on the feature);
the drilling of one or more recesses in the substrate, in order to bring the microstructure(s) and the outside into relationship and thus allow fluids to enter and leave. The orifices may be located on one or both substrates. Preferably, the drilling is carried out on the substrate before step a) or after step b) in the case of open devices, and on the first substrate before step a) and/or on the second substrate after assembly in the case of closed devices;
the application of at least one polymer film to at least one of the faces of the microfluidic device(s), especially to increase the impact strength of the microfluidic device;
the chemical or physical treatment of the internal surface of at least one microstructure, for example to improve the compatibility with the fluids used, such as a hydrophilic or lipophilic treatment; and
the insertion of attached parts, for example electrodes, magnets, valves, seals and connection elements of any type.

Particularly advantageously, the fabrication of the open microfluidic device(s) is carried out by the method consisting in:
depositing a mixture of at least a glass frit and an organic medium on a glass substrate, coated with a functional layer, by screen-printing in order to form a plurality of identical or different screen-printed features;
firing said screen-printed features;
cutting the substrate between the features and collecting the microfluidic devices; and
optionally applying a polymer film to the surface of one or more microfluidic devices in order to completely or partly close off the microstructures.

Particularly advantageously, the fabrication of the closed microfluidic device(s) is carried out by the method which consists in:
depositing a mixture of at least one glass frit and an organic medium on a glass substrate coated with a discontinuous functional layer by screen-printing in order to form a plurality of identical or different screen-printed features;
drying the screen-printed feature(s) at a temperature sufficient to remove the organic medium;
depositing a second glass substrate with dimensions similar to a first substrate on said features, said second substrate preferably including at least one recess;
firing the assembly obtained at a temperature allowing the precursor material to bond to the substrates by melting; and
cutting the substrates between the features and collecting the microfluidic devices.

In one or other of the aforementioned particularly advantageous methods, the functional layer is electrically conducting.

The microfluidic devices obtained in accordance with the invention have microstructures with an approximately square or rectangular cross section, which may be slightly rounded on the first substrate, having a depth that may range up to 1000 μm, preferably between 5 and 200 μm, and advantageously between 10 and 100 μm. The devices made entirely of glass are beneficial in that the constituent substrate or substrates have a small thickness and are transparent, thereby enabling them to be used in optical detection techniques.

The invention will be better understood by reference to the following figures.

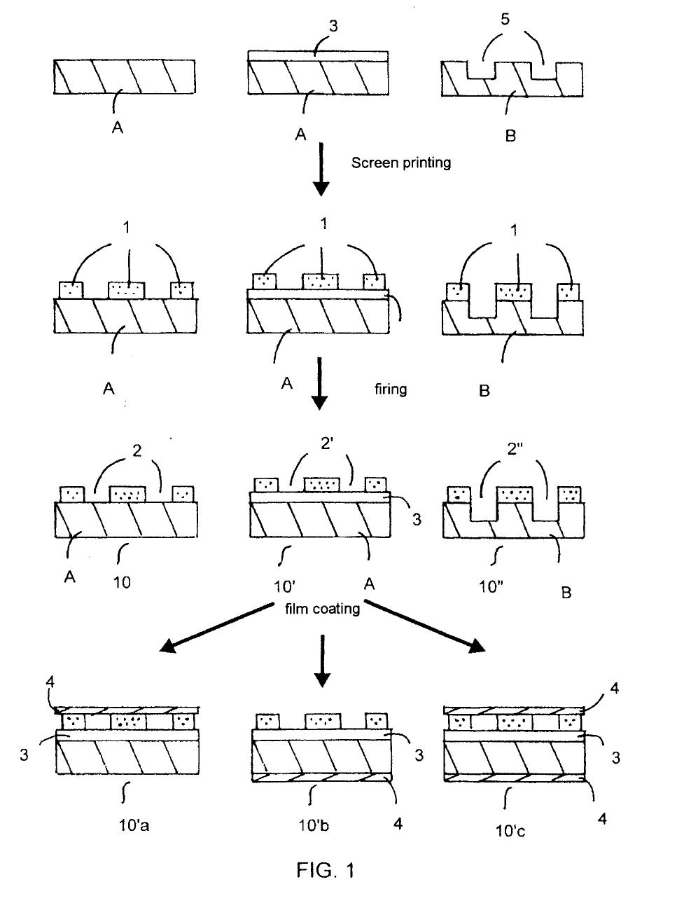

FIG. 1 describes, schematically, the steps of the method for fabricating one or more open microfluidic devices according to three variants.

According to the first variant, a screen-printing screen (not shown) on which the desired features are reproduced is placed on the bare substrate A and a glass, glass-ceramic or ceramic precursor mixture is passed through the screen by means of a squeegee. Screen-printed features 1 are thus formed on the substrate. The substrate is then heat-treated so as to melt the precursor mixture and bond it lastingly to the substrate. The microfluidic device 10 contains the microstructures 2.

According to the second variant, the substrate A is coated with a functional layer 3, for example an electrically conducting layer. Screen-printed features 1 are deposited under the conditions of the first variant and the substrate is heat-treated so as to form the microfluidic device 10′ which contains the microstructures 2′, the lower internal face of which is coated with the functional layer 3. In this variant, a polymer film 4 is applied to the features 1 after the firing (on the upper face) so as to form a “cover” (device 10′a), on the glass substrate (lower face) in particular to act as a reinforcement (device 10′b) or on the lower and upper faces (device 10′c).

According to the third variant, the substrate B includes microstructures 5 etched on the surface, for example microchannels. Screen-printed features 1 are deposited on the substrate under the conditions of the first variant, by placing the features opposite the microstructures, and the substrate is heat-treated to form the microfluidic device 10″. The microstructures 2″ thus obtained may have a large volume.

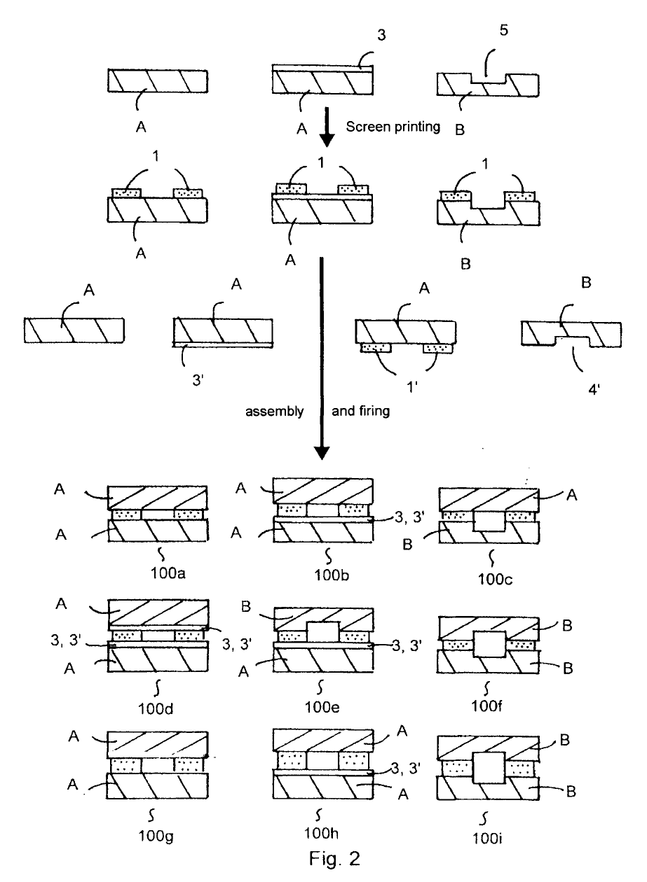

FIG. 2, describes, again schematically, the steps of the method for fabricating one or more closed microfluidic devices and the various microfluidic devices that can be obtained.

The substrate may be a bare substrate A, a substrate A coated with a functional layer 3, or a substrate B that includes surface-etched microstructures 5.

Features 1 screen-printed under the conditions described in the first variant of FIG. 1 are deposited on the aforementioned substrate. The substrate provided with the features is heat-treated at a temperature ensuring removal of the medium and consolidation of the screen-printed features 1.

The substrate coated with the features 1 is assembled with a second substrate, which may be a bare substrate A, a substrate A coated with a continuous functional layer 3′, a substrate A bearing screen-printed features 1′, or a substrate B that includes etched microstructures 4′.

The combination of the substrates is heat-treated at a temperature suitable for melting the glass, glass-ceramic or ceramic precursor material and bonding it to the substrates.

The microfluidic devices that can be obtained by combining the various substrates are denoted by 100a to 100i.

The exemplary embodiment given below allows the invention to be illustrated, without however limiting it.

### EXAMPLE 1

Two identical features were formed by screen-printing on a sheet of soda-lime-silica glass (dimensions: L=10 cm; I=10 cm; thickness=0.7 mm), each feature corresponding to a microfluidic device in the form of a H composed of two rectangles measuring 2 cm×1 cm spaced apart by 4 cm and connected at the middle by a line 0.2 cm in width.

To produce the features, a screen-printing paste was used that was obtained by mixing, in a disk disperser operating at a speed of 3000 revolutions per minute, 34 parts by weight of a medium based on castor oil and thixotropic agents (reference 80840, sold by Ferro) and 100 parts by weight of a low-melting-point lead-free zinc-borate glass frit (d₅₀=5 μm; reference VN821 BJ sold by Ferro).

The mixture was deposited on the glass sheet by means of a screen-printing screen made up of 80 to 200 polyester yarns per centimeter to a thickness of around 15 microns. It was then dried at 100° C. for a few minutes.

Placed on the glass sheet bearing the screen-printed features was a second sheet of soda-lime-silica glass with the same dimensions as the first sheet, provided with circular holes emerging in the above-defined rectangles (two holes per rectangle; four holes per feature). The assembly formed by the two sheets was introduced into a furnace and heated under the following conditions: heating to a temperature of 600° C. at a rate of 10° C. per minute, maintaining 600° C. for five minutes, and cooling to room temperature at a rate of 10° C. per minute.

The assembly was cut between the features on both glass sheets by a laser and the microfluidic devices were collected.

The channels of these devices had a depth of the order of 10 microns.

1. A method of fabricating a microfluidic device comprising a substrate provided with at least one microstructure, comprising:
a) depositing a mixture of a glass, glass ceramic or ceramic precursor material and of an organic medium onto said substrate, which is made of a material selected from the group consisting of glass, glass ceramic and ceramic, by screen printing to form at least one screen printed feature in a desired pattern, each feature corresponding to a microfluidic device; and
b) firing the at least one screen printed feature at a temperature allowing the precursor material to bond to the substrate by melting.

2. The method as claimed in claim 1, further comprising cutting the substrate after said depositing.

3. The method as claimed in claim 2, wherein said cutting is carried out after said firing.

4. The method as claimed in claim 1, wherein the substrate is coated with a functional layer on all or part of the face on which the screen printing mixture is deposited.

5. The method as claimed in claim 1, wherein the substrate has microstructures on all or part of the face on which the screen printing mixture is deposited.

6. The method as claimed in claim 1, further comprising drilling at least one recess in the substrate to bring the at least one microstructure and the outside into relationship.

7. The method as claimed in claim 6, wherein the drilling is carried out on the substrate before said depositing or after step b) said firing.

8. The method as claimed in claim 1, further comprising chemically or physically treating the internal surface of at least one microstructure.

9. The method as claimed in claim 1, further comprising applying at least one polymer film on at least one of the faces of the microfluidic device.

10. The method as claimed in claim 1, comprising:
depositing a mixture of at least a glass frit and an organic medium on a glass substrate, coated with a functional layer, by screen printing to form a plurality of identical or different screen printed features;
firing said screen printed features; and
cutting the substrate between the features and collecting the microfluidic devices.

11. The method as claimed in claim 10, wherein the functional layer is an electrically conducting layer.

12. A method of fabricating microfluidic devices comprising a first substrate, a second substrate, and at least one microstructure, comprising:
a) depositing a mixture of a glass, glass ceramic or ceramic precursor material and of an organic medium on a first substrate by screen printing to form at least one screen printed feature in a desired pattern, said first substrate comprising a material selected from the group consisting of glass, glass ceramic and ceramic, and each feature corresponding to a microfluidic device;
c) depositing a second substrate comprising a material selected from the group consisting of glass, glass ceramic and ceramic, which is identical to or different from said first substrate, on the at least one screen printed feature; and
d) firing the assembly obtained at a temperature allowing the precursor material to bond to the substrates by melting.

13. The method as claimed in claim 12, further comprising cutting at least one of the first substrate and the second substrate.

14. The method as claimed in claim 12, wherein the first substrate is cut after said depositing, and the second substrate is cut after said firing.

15. The method as claimed in claim 12, wherein the first substrate is coated with a functional layer or comprises microstructures on all or part of the face on which the screen printing mixture is deposited.

16. The method as claimed in claim 12, wherein the second substrate is coated with a functional layer, covered with features screen printed using a mixture of a glass, glass ceramic or ceramic precursor material and an organic medium, or comprises microstructures, on all or part of the face on which the screen printing mixture is deposited.

17. The method as claimed in claim 12, wherein spacers are deposited before the substrates are assembled.

18. The method as claimed in claim 17, wherein the spacers are introduced into the screen printing mixture or are deposited in the form of a glass frit on at least one of the first substrate and the second substrate.

19. The method as claimed in claim 18, wherein the glass frit is deposited outside the feature or between the features.

20. The method as claimed in claim 12, further comprising drilling at least one recess in at least one of the first substrate and the second substrate to bring the at least one microstructure and the outside into relationship.

21. The method as claimed in claim 20, wherein the drilling is carried out on at least one of the first substrate and the second substrate before the substrates are assembled.

22. The method as claimed in claim 12, further comprising applying at least one polymer film on at least one of the faces of the microfluidic device.

23. The method as claimed in claim 12, further comprising chemically or physically treating the internal surface of at least one microstructure.

24. The method as claimed in claim 12, comp
depositing a mixture of at least one glass frit and an organic medium on a glass substrate coated with a discontinuous functional layer by screen printing to form a plurality of identical or different screen printed features;
drying said screen printed features at a temperature sufficient to remove the organic medium;
depositing a second glass substrate with dimensions similar to the first substrate on said features;
firing the assembly obtained at a temperature allowing the precursor material to bond to the substrates by melting; and
cutting the substrates between the features and collecting the microfluidic devices.

25. The method as claimed in claim 24, wherein the functional layer is an electrically conducting layer.

26. The method as claimed in claim 10, further comprising applying a polymer film to the surface of at least one microfluidic device to completely or partly close off the microstructures.

27. The method as claimed in claim 12, further comprising drying said at least one screen printed feature at a temperature sufficient to remove the organic medium;

28. The method as claimed in claim 24, wherein said second substrate has at least one recess.
